(19) United States
(12) Patent Application Publication
(10) Pub. No.: US 2025/0365771 A1
(43) Pub. Date: Nov. 27, 2025

(54) FLEXIBLE INITIAL ACCESS CHANNEL CONFIGURATIONS

(71) Applicant: Nokia Technologies Oy, Espoo (FI)

(72) Inventors: Kari Juhani HOOLI, Oulu (FI); Vitaly PETROV, Espoo (FI); Mark CUDAK, Rolling Meadows, IL (US); Sami-Jukka HAKOLA, Kempele (FI)

(73) Assignee: Nokia Technologies Oy, Espoo (FI)

(21) Appl. No.: 18/874,313

(22) PCT Filed: Jun. 14, 2022
(86) PCT No.: PCT/US2022/033341

§ 371 Date: Dec. 12, 2024

(51) Int. Cl. H04W 74/0833; H04B 7/06; H04L 5/00

(52) U.S. Cl. CPC H04W 74/0833; H04B 7/0626; H04L 5/0098

(57) ABSTRACT

There is herein in accordance with example embodiments of the invention at least a method and apparatus to determining, that a user equipment is to access a cell for triggering random access to the cell using an initial access configuration communicated by a network node of the communication network to perform operations such as a data shower coverage for the user equipment, wherein the initial access configuration is sequentially using more than one pattern of at least one of a synchronization signal, a beacon, or a channel state information reference signal for at least one of acquiring synchronization, beam refinement, and beam maintenance for access to the cell.

### TECHNICAL FIELD

The teachings in accordance with the exemplary embodiments of this invention relate generally to reducing delay in beam refinement and synchronization for cell access and, more specifically, relate to reducing delay in beam refinement and synchronization for cell access using flexible initial access configurations.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
BS Base Station
CORESET 0 Control Resource Set
CSI-RS Channel State Information Reference Signal
DL Downlink
DS Data Shower
gNB 5G Node B, base station
IE Information Element
IR invention report
MCG Master Cell Group
MCS Modulation and Coding scheme
MIB Master Information Block
NR New Radio
PBCH Physical Broadcast Channel
PCell Primary Serving Cell
PDCCH Physical Downlink Control Channel
PL Path Loss
PRACH Physical Random Access Channel
RA Random Access
RAN Radio Access Network
RAT Radio Access Technology
SCell Secondary Cell
SCG Secondary Cell Group
SIB System Information Block
SS Synchronization Signal
SSB SS/PBCH Block
THz Terahertz
UE User Equipment
UL Uplink
VLC Visual Light Communications
WI Working Item
3GPP 3rd Generation Partnership Project

Even though the landscape of 6G wireless systems is currently at the early stage of its development, it is already clear that one of the major focuses would be on the support for rate-hungry futuristic scenarios, such as ubiquitous penetration of extended reality (XR) systems, holographic telepresence, and collective driving by autonomous robots.

Concerning the extreme data rates to be supported, 6G systems are expected to complement existing sub-5GHz and mm Wave connectivity options with wireless communications over frequencies above 71 GHz. These novel connectivity options will be featured by large portions of continuous spectrum thus enabling data rates that are considerably higher than ones offered at 5 GHz (FR1), 28 GHz (FR2), or even recently adopted 60 GHz (FR2-2).

One of the challenges though in enabling wireless at frequencies over 71 GHz, going toward sub-THz (<300GHz) and, ultimately, THz (>300GHz) and visual lights (VLC) regions, is the limited effective communication range.

Example embodiments of the invention as disclosed herein work to address at least some of these challenges.

### SUMMARY

This section contains examples of possible implementations and is not meant to be limiting.

In an example aspect of the invention, there is an apparatus, such as a user equipment side apparatus, comprising: at least one processor; and at least one memory including computer program code, where the at least one memory and the computer program code are configured, with the at least one processor, to cause the apparatus to perform at least: determining, by a user equipment of a communication network, that the user equipment is to access a cell for triggering random access to the cell, wherein the random access is using an initial access configuration communicated by a network node of the communication network, wherein the initial access configuration is sequentially using more than one pattern of at least one of a synchronization signal, a beacon, or a channel state information reference signal for at least one of acquiring synchronization, beam refinement, and beam maintenance for access to the cell; and based on the initial access configuration, performing random access with the cell.

In another example aspect of the invention, there is a method comprising: determining, by a user equipment of a communication network, that the user equipment is to access a cell for triggering random access to the cell, wherein the random access is using an initial access configuration communicated by a network node of the communication network, wherein the initial access configuration is sequentially using more than one pattern of at least one of a synchronization signal, a beacon, or a channel state information reference signal for at least one of acquiring synchronization, beam refinement, and beam maintenance for access to the cell; and based on the initial access configuration, performing random access with the cell.

A further example embodiment is an apparatus and a method comprising the apparatus and the method of the previous paragraph wherein the network node comprises a primary serving cell and wherein the cell comprises a sub-terahertz secondary cell, and wherein the access to the sub-terahertz secondary cell is to perform data shower coverage for the user equipment, and wherein the access to the sub-terahertz secondary cell is to perform data shower coverage for the user equipment, wherein determining to access the sub-terahertz secondary cell is based on an indication from the network node, and wherein the access to the sub-terahertz secondary cell is to perform data shower coverage for the user equipment, wherein the more than one pattern are sequentially switched based on at least one of a configured time window, expiration of a timer, or receiving a predefined message from the network node, wherein the determining is based on at least one of a lower layer path loss or measurement, position, velocity, or direction reported from the user equipment to the network node, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window, wherein initial positions of a subset of synchronization signal blocks of the synchronization signal block transmission provide an initial synchronization pattern of the more than one pattern, wherein the positions of the subset of synchronization signal blocks of the synchronization signal block transmission occur in intervals and numbers that are shorter than other synchronization signal block patterns of the communication network to make them occur more densely while intervals of the synchronization signal block transmission remain standardized, wherein the beam maintenance is using a synchronization maintenance pattern, wherein the more than one pattern comprises at least a second configuration comprising a synchronization signal block transmission with a second periodicity and configuration for a second time window used for beam refinement, wherein there is following random access, determining the beam refinement based on a switch to a synchronization signal block pattern and a channel state information reference signal pattern provided by the network node, wherein the switch occurs at the end of the first time window or when the user equipment receives a predefined message from network, wherein determining the beam refinement comprises utilizing a second configuration comprising a synchronization signal block transmission with a second periodicity and configuration, wherein the second periodicity occur in intervals and numbers that are greater than other synchronization signal block transmissions of the communication network, and wherein the second periodicity is longer than the first periodicity, wherein the more than one pattern comprises at least a third configuration and there is following determining the beam refinement, utilizing a third configuration for a synchronization signal block and channel state information reference signal transmission with the second periodicity and configuration for the beam refinement, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns, wherein the densely provided channel state information reference signal pattern utilizes a timer to indicate a maximum duration of a first configuration related to an initial synchronization burst relative to a time instant derived based on message timing for the random access, wherein a second configuration is used after the timer expires, wherein the more than one pattern comprises at least one bit map indicating at least one of ssb-InitialPositions or CSIRS-RefinementPositions, wherein the more than one pattern comprises at least a third configuration for beam maintenance, wherein the third configuration comprising: following determining the beam refinement, utilizing the third configuration for a synchronization signal block with at least one of a fourth periodicity, or channel state information reference signal transmission with a fifth periodicity, wherein the initial access configuration is received from the network node prior to the random access, wherein there is, based on the determining, indicating a preferred modulation and coding scheme for a downlink data transmission in a random access message to the network node, and wherein the downlink data transmission is received from the network node using an aggressive modulation and coding scheme selection in response to information received in the random access message and before a channel state information report.

A non-transitory computer-readable medium storing program code, the program code executed by at least one processor to perform at least the method as described in the paragraphs above.

In yet another example aspect of the invention, there is an apparatus comprising: means for determining (TRANS 13D, MEM 10B, PROG 10C, and DP 10A as in FIG. 5), by a user equipment (UE 10 as in FIG. 5) of a communication network (Network 1 as in FIG. 5), that the user equipment is to access a cell for triggering random access to the cell, wherein the random access is using an initial access configuration communicated (TRANS 13D, MEM 10B, PROG 10C, and DP 10A as in FIG. 5) by a network node (NN 12 and/or NN 13 as in FIG. 5) of the communication network, and wherein the initial access configuration is sequentially using (TRANS 13D, MEM 10B, PROG 10C, and DP 10A as in FIG. 5) more than one pattern of at least one of a synchronization signal, a beacon, or a channel state information reference signal for at least one of acquiring synchronization, beam refinement, and beam maintenance for access to the cell.

In the example aspect of the invention according to the paragraph above, wherein at least the means for determining, communicating, and using comprises a non-transitory computer readable medium [MEM 10B as in FIG. 5] encoded with a computer program [PROG 10C as in FIG. 5] executable by at least one processor [DP 10A as in FIG. 5].

In accordance with the example embodiments as described in the paragraph above, at least the means for determining, communicating, and using comprises a network interface, and computer program code stored on a computer-readable medium and executed by at least one processor.

In another example aspect of the invention, there is an apparatus, such as a network side apparatus, comprising: at least one processor; and at least one non-transitory memory including computer program code, where the at least one memory and the computer program code are configured, with the at least one processor, to cause the apparatus to perform at least: determining, by a network node of a communication network, that a user equipment is to access a cell to trigger random access to the cell for the user equipment; based on the determining, sending an initial access configuration towards the user equipment for triggering random access to the cell for the user equipment, wherein the initial access configuration is sequentially using more than one pattern of at least one of a data shower cell synchronization signal, a beacon, or a channel state information reference signal for at least one of acquiring synchronization, beam refinement, and beam maintenance for access to the cell.

In still another example aspect of the invention, there is a method comprising: determining, by a network node of a communication network, that a user equipment is to access a cell to trigger random access to the cell for the user equipment; based on the determining, sending an initial access configuration towards the user equipment for triggering random access to the cell for the user equipment, wherein the initial access configuration is sequentially using more than one pattern of at least one of a data shower cell synchronization signal, a beacon, or a channel state information reference signal for at least one of acquiring synchronization, beam refinement, and beam maintenance for access to the cell.

A further example embodiment is an apparatus and a method comprising the apparatus and the method of the previous paragraph, wherein the network node comprises a primary serving cell and wherein the cell comprises a sub-terahertz secondary cell and wherein the initial access configuration is received from the network node through a frequency band lower than a frequency band of the cell, wherein the initial access channel configuration is communicated by network node through a frequency band lower than a frequency band of the cell, wherein the access to the sub-terahertz secondary cell is to perform data shower coverage for the user equipment, wherein the more than one pattern are sequentially switched based on at least one of a configured time window, expiration of a timer, or a predefined message from the network node, wherein the determining is based on at least one of a lower layer path loss report or measurement, position, velocity, or direction reported from the user equipment, wherein the more than one pattern is sequentially switched based on at least one of a configured time window, expiration of a timer, or a predefined message from the network node, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window, wherein initial positions of a subset of synchronization signal blocks of the synchronization signal block transmission provide an initial synchronization pattern of the more than one pattern, wherein the positions of the subset of synchronization signal blocks of the synchronization signal block transmission occur in intervals and numbers that are shorter than other synchronization signal block patterns of the communication network to make them occur more densely while intervals of the synchronization signal block transmission remain standardized, wherein there is following a random access procedure to the sub-terahertz secondary cell by the user equipment, determining a beam refinement based on a switch to a synchronization signal block pattern and a channel state information reference signal pattern provided by the network node, wherein the switch occurs at the end of the first time window or when the user equipment receives a predefined message from network, wherein determining the beam refinement comprises utilizing a second configuration comprising a synchronization signal block transmission with a second periodicity and configuration, wherein the second periodicity occur in intervals and numbers that are greater than other synchronization signal block transmissions of the communication network, and wherein the second periodicity is longer than the first periodicity, wherein there is following determining the beam refinement, a third configuration is utilized for a synchronization signal block and channel state information reference signal transmission with the second periodicity and configuration for the beam refinement, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns, wherein the densely provided channel state information reference signal pattern utilizes a timer to indicate a maximum duration of a first configuration related to an initial synchronization burst relative to a time instant derived based on message timing for the random access, wherein a second configuration is used after the timer expires, wherein the more than one pattern comprises at least one bit map indicating at least one of ssb-InitialPositions or CSIRS-RefinementPositions, wherein the more than one pattern comprises at least a third configuration for beam maintenance, wherein the third configuration comprising: following determining the beam refinement, utilizing the third configuration for a synchronization signal block with at least one of a fourth periodicity, or channel state information reference signal transmission with a fifth periodicity, wherein the initial channel configuration is communicated by the network node prior to the random access, wherein the initial access channel configuration is communicated based on a preferred modulation and coding scheme carrying a system information block in a message 3 physical uplink shared channel communicated to the network node from the user equipment, wherein the initial access channel configuration is communicated by the network node to the user equipment using an aggressive modulation and coding scheme selection in response to information received in the message 3 and before a channel state information report, wherein there is receiving from the user equipment a preferred modulation and coding scheme for a downlink data transmission in a random access message, and wherein the downlink data transmission is received using an aggressive modulation and coding scheme selection in response to information received in the random access message and before a channel state information report.

A non-transitory computer-readable medium storing program code, the program code executed by at least one processor to perform at least the method as described in the paragraphs above.

In yet another example aspect of the invention, there is an apparatus comprising: means for determining (TRANS 12D and/or TRANS 13D, MEM 12B and/or MEM 13B, PROG 12C and/or PROG 13C, and DP 12A and/or DP 13A as in FIG. 5), by a network node (NN 12 and/or NN 13 as in FIG. 5) of a communication network (Network 1 as in FIG. 5), that a user equipment (UE 10 as in FIG. 5) is to access a cell to trigger random access to the cell for the user equipment; means, based on the determining, for sending (TRANS 12D and/or TRANS 13D, MEM 12B and/or MEM 13B, PROG 12C and/or PROG 13C, and DP 12A and/or DP 13A as in FIG. 5) an initial access configuration towards the user equipment for triggering random access to the cell to perform a data shower coverage for the user equipment, wherein the initial access configuration is sequentially using (TRANS 12D and/or TRANS 13D, MEM 12B and/or MEM 13B, PROG 12C and/or PROG 13C, and DP 12A and/or DP 13A as in FIG. 5) more than one pattern of at least one of a data shower cell synchronization signal, a beacon, or a channel state information reference signal for at least one of acquiring synchronization, beam refinement, and beam maintenance for access to the cell.

In the example aspect of the invention according to the paragraph above, wherein at least the means for determining, sending, and using comprises a non-transitory computer readable medium [MEM 12B and/or MEM 13B as in FIG. 5] encoded with a computer program [PROG 12C and/or PROG 13C as in FIG. 5] executable by at least one processor [DP 12A and/or DP 13C as in FIG. 5].

In accordance with the example embodiments as described in the paragraph above, at least the means for determining, sending, and using comprises a network interface, and computer program code stored on a computer-readable medium and executed by at least one processor.

In still another example aspect of the invention, there is an apparatus, such as a network side apparatus, comprising: at least one processor; and at least one non-transitory memory including computer program code, where the at least one memory and the computer program code are configured, with the at least one processor, to cause the apparatus to perform at least: determining, by a cell of a communication network, that a user equipment is to access the cell; based on the determining, receiving an initial access channel configuration via the user equipment triggering random access to the cell to perform a data shower coverage for the user equipment, wherein the initial access channel configuration is sequentially using more than one pattern of at least one of a data shower cell synchronization signal, a beacon, or a channel state information reference signal for beam refinement and acquiring synchronization for access and activation of the cell for the data shower coverage.

In still another example aspect of the invention, there is a method comprising: determining, by a cell of a communication network, that a user equipment is to access the cell; based on the determining, receiving an initial access channel configuration via the user equipment triggering random access to the cell to perform a data shower coverage for the user equipment, wherein the initial access channel configuration is sequentially using more than one pattern of at least one of a data shower cell synchronization signal, a beacon, or a channel state information reference signal for beam refinement and acquiring synchronization for access and activation of the cell for the data shower coverage.

A further example embodiment is an apparatus and a method comprising the apparatus and the method of the previous paragraph, wherein the cell comprises a sub-terahertz secondary cell, wherein the cell comprises a sub-terahertz secondary cell, and wherein the access to the sub-terahertz secondary cell is to perform data shower coverage for the user equipment and wherein the access to the sub-terahertz secondary cell is to perform data shower coverage for the user equipment, wherein the initial access channel configuration is communicated from a network node of the communication network through a frequency band lower than a frequency band of the cell, wherein the more than one pattern are sequentially switched based on at least one of a configured time window, expiration of a timer, or a predefined message from the network node, wherein the more than one pattern is sequentially switched based on at least one of a configured time window, expiration of a timer, or a predefined message from the network node, wherein the determining is based on at least one of a lower layer path loss report or measurement, position, velocity, or direction reported from the user equipment, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window, wherein initial positions of a subset of synchronization signal blocks of the synchronization signal block transmission provide an initial synchronization pattern of the more than one pattern, wherein the positions of the subset of synchronization signal blocks of the synchronization signal block transmission occur in intervals and numbers that are shorter than other synchronization signal block patterns of the communication network to make them occur more densely while intervals of the synchronization signal block transmission remain standardized, wherein there is following a random access procedure to the cell by the user equipment, determining a beam refinement based on a switch to a synchronization signal block pattern and a channel state information reference signal pattern provided by the network node, wherein the switch occurs at the end of the first time window or when the user equipment receives a predefined message from network, wherein determining the beam refinement comprises utilizing a second configuration comprising a synchronization signal block transmission with a second periodicity and configuration, wherein the second periodicity occur in intervals and numbers that are greater than other synchronization signal block transmissions of the communication network, and wherein the second periodicity is longer than the first periodicity, wherein there is following determining the beam refinement, a third configuration is utilized for a synchronization signal block and channel state information reference signal transmission with the second periodicity and configuration for the beam refinement, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns, wherein the densely provided channel state information reference signal pattern utilizes a timer to indicate a maximum duration of a first configuration related to an initial synchronization burst relative to a time instant derived based on message timing for the random access, wherein a second configuration is used after the timer expires, wherein the more than one pattern comprises at least one bit map indicating at least one of ssb-InitialPositions or CSIRS-RefinementPositions, wherein the more than one pattern comprises at least a third configuration for beam maintenance, wherein the third configuration comprising: following determining the beam refinement, utilizing the third configuration for a synchronization signal block with at least one of a fourth periodicity, or channel state information reference signal transmission with a fifth periodicity, wherein the initial access channel configuration is communicated by the network node in response to the random access, wherein the initial access channel configuration is communicated based on a preferred modulation and coding scheme carrying a system information block in a message 3 physical uplink shared channel communicated to the network node from the user equipment, and wherein the initial access channel configuration is using an aggressive modulation and coding scheme selection in response to information received in the message 3 and before a channel state information report.

A non-transitory computer-readable medium storing program code, the program code executed by at least one processor to perform at least the method as described in the paragraphs above.

In yet another example aspect of the invention, there is an apparatus comprising: means for determining (TRANS 12D and/or TRANS 13D, MEM 12B and/or MEM 13B, PROG 12C and/or PROG 13C, and DP 12A and/or DP 13A as in FIG. 5), by a cell of a communication network (Network 1 as in FIG. 5), that a user equipment (UE 10 as in FIG. 5) is to access the cell; means, based on the determining, for receiving (TRANS 12D and/or TRANS 13D, MEM 12B and/or MEM 13B, PROG 12C and/or PROG 13C, and DP 12A and/or DP 13A as in FIG. 5) an initial access channel configuration via the user equipment triggering (TRANS 12D and/or TRANS 13D, MEM 12B and/or MEM 13B, PROG 12C and/or PROG 13C, and DP 12A and/or DP 13A as in FIG. 5) random access to the cell to perform a data shower coverage for the user equipment, wherein the initial access channel configuration is sequentially using (TRANS 12D and/or TRANS 13D, MEM 12B and/or MEM 13B, PROG 12C and/or PROG 13C, and DP 12A and/or DP 13A as in FIG. 5) more than one pattern of at least one of a data shower cell synchronization signal, a beacon, or a channel state information reference signal for beam refinement and acquiring synchronization for access and activation of the cell for the data shower coverage.

In the example aspect of the invention according to the paragraph above, wherein at least the means for determining, receiving, triggering, and using comprises a non-transitory computer readable medium [MEM 12B and/or MEM 13B as in FIG. 5] encoded with a computer program [PROG 12C and/or PROG 13C as in FIG. 5] executable by at least one processor [DP 12A and/or DP 13C as in FIG. 5].

In accordance with the example embodiments as described in the paragraph above, at least the means for determining, receiving, triggering, and using comprises a network interface, and computer program code stored on a computer-readable medium and executed by at least one processor.

A communication system comprising the network side apparatus and the user equipment side apparatus performing at least operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a ServingCellConfigCommon information element;

FIG. 2 shows a flexible synchronization signal block design;

FIG. 3 shows a flow chart of one proposed solution in accordance with example embodiments of the invention;

FIG. 4 shows an example of the proposed flexible synchronization signal block configuration in accordance with example embodiments of the invention;

FIG. 5 shows a high level block diagram of various devices used in carrying out various aspects of the invention; and

FIG. 6A, FIG. 6B, and FIG. 6C each show a method in accordance with example embodiments of the invention which may be performed by an apparatus.

### DETAILED DESCRIPTION

In example embodiments of this invention, there is provided at least a method and apparatus to reduce delay in beam refinement and synchronization for cell access using flexible initial access configurations.

As similarly stated above, even though the landscape of 6G wireless systems is currently at the early stage of its development, it is clear that one of the major focuses would be on the support for rate-hungry futuristic scenarios, such as ubiquitous penetration of extended reality (XR) systems, holographic telepresence, and collective driving by autonomous robots.

Thus, concerning the high data rates to be supported, 6G systems are expected to complement existing sub-5GHz and mm Wave connectivity options with wireless communications over frequencies above 71 GHz. These novel connectivity options will be featured by large portions of continuous spectrum thus enabling data rates that are considerably higher than ones offered at 5 GHz (FR1), 28 GHz (FR2), or even recently adopted 60 GHz (FR2-2).

One of the challenges though in enabling wireless at frequencies over 71 GHz, going toward sub-THz (<300GHz) and, ultimately, THz (>300GHz) and visual lights (VLC) regions, is the limited effective communication range.

Hence, it is envisioned that at least the first generations of these systems would not be fully covering large areas, but rather providing sporadic coverage in strategically chosen locations that have a high density and/or a high flow of UEs. The latter leads to the consideration of a “data shower” (DS) or “information shower”—extremely high rate but relatively short-range access point (AP) as one of the possible use cases for wireless access above 71 GHz.

One of the challenges in utilizing data showers is the relatively short contact time—the time the UE is in the DS coverage—between a moving UE and a DS. In certain practical scenarios, such as a moving connected vehicle and an information shower on the intersection, the contact time could be as low as a few seconds. In this case, the contact time should be utilized efficiently, minimizing the signaling overhead when joining/leaving the AP and thus maximizing the fraction of resources dedicated to transferring large portions of data at extremely high rates.

Sub-THz and higher frequency DSs are also envisioned to operate with narrow beams of no more than few degrees wide to improve coverage and throughput. On other hand, narrow beams will complicate further the initial access and beam acquisition and refinement phases.

It is thus desirable to reduce the time and resources needed to support initial access procedures and channels with DSs.

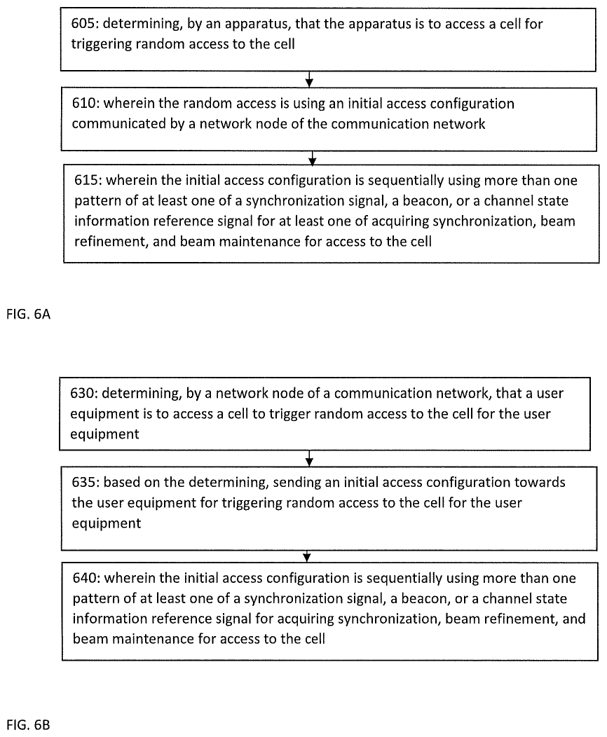

FIG. 5 shows a high level block diagram of various devices used in carrying out various aspects of the invention.

Before describing the example embodiments of the invention in detail, reference is made to FIG. 5 for illustrating a simplified block diagram of various electronic devices that are suitable for use in practicing the example embodiments of this invention.

FIG. 5 shows a block diagram of one possible and non-limiting exemplary system in which the example embodiments of the invention may be practiced. In FIG. 5, a user equipment (UE) 10 is in wireless communication with a wireless network 1 or network, 1 as in FIG. 5. The wireless network 1 or network 1 as in FIG. 5 can comprise a communication network such as a mobile network e.g., the mobile network 1 or first mobile network as disclosed herein. Any reference herein to a wireless network 1 as in FIG. 5 can be seen as a reference to any wireless network as disclosed herein. Further, the wireless network 1 as in FIG. 5 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 14.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 5. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices an such as, but not limited to NCE/MME/SGW/UDM/PCF/AMF/SMF/LMF 14 device as in FIG. 5. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 14 or another link. The Link 14 as shown in FIG. 5 can be used for communication between the NN12 and the NN13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF/LMF 14 of FIG. 5.

The one or more buses of the device of FIG. 5 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to an RRH.

It is noted that although FIG. 5 shows a network nodes such as NN 12 and NN 13, any of these nodes can incorporate or be incorporated into an eNodeB or eNB or gNB such as for LTE and NR, and would still be configurable to perform example embodiments of the invention.

Also, it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB. Further, it is noted that example embodiments of the invention can be used in any type of radio communication cell such as but not limited to an LTE, NR, terahertz, or sub-terahertz cell.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 14. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g., based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF the such as the LMF of MME/SGW/UDM/PCF/AMF/SMF/LMF 14 of FIG. 5, as at least described below, can be co-located with UE 10 such as to be separate from the NN 12 and/or NN 13 of FIG. 5 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

As stated above It is thus desirable to reduce the time and resources needed to support initial access procedures and channels with DSs.

In state-of-the-art design, the IE ServingCellConfigCommon is used to configure cell specific parameters of a UE's serving cell. The IE contains parameters which a UE would typically acquire from SSB, MIB or SIBs when accessing the cell from IDLE. With this IE, the network provides this information in dedicated signaling when configuring a UE with a SCells or with an additional cell group (SCG). It also provides it for SpCells (MCG and SCG) upon reconfiguration with sync.

In accordance with an example embodiment of the invention, the BS providing a primary cell determines that UE should try to access a sub-terahertz secondary cell, after which UE will try to access the sub-terahertz secondary cell (using the initial access configuration that UE receives from primary cell).

In accordance with another example embodiment of the invention, a UE and a BS providing secondary sub-terahertz cell will determine (during random access process) if the UE's access to secondary sub-terahertz cell is successful or not.

Further, in accordance with an example embodiment of the invention a BS providing a primary cell indicates to BS or network node controlling and providing sub-terahertz secondary cell about UE suitable to access the sub-terahertz secondary cell.

In addition, the BS or network node controlling sub-terahertz secondary cell that determines the initial access configuration, which is indicated to the UE via the primary cell prior UE, tries to access the sub-terahertz secondary cell.

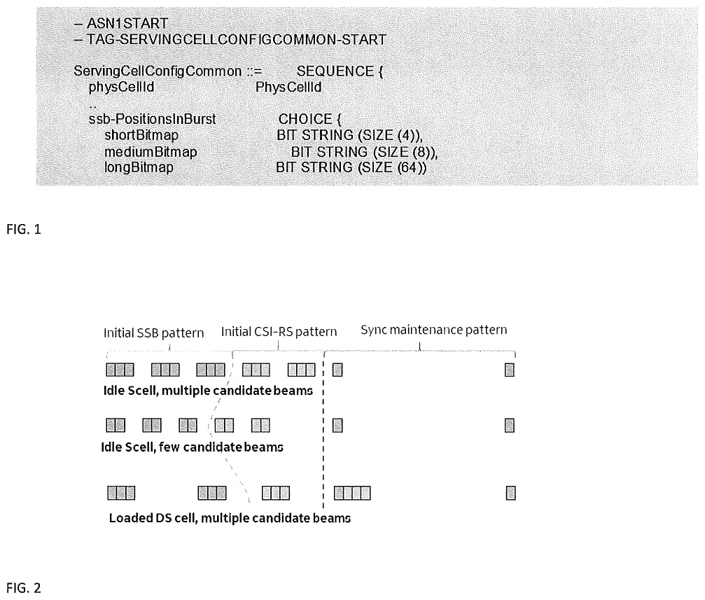

FIG. 1 shows a ServingCellConfigCommon information element

With regards to FIG. 1. There is:
SSB-PositionsInBurst

The ssb-PositionsInBurst indicates the time domain positions of the transmitted SS-blocks in a half frame with SS/PBCH blocks as defined in TS 38.213, clause 4.1. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted. The network configures the same pattern in this field as in the corresponding field in ServingCellConfigCommonSIB.

In prior art at the time of this application, a single semi-static SSB pattern is configured and SSB locations in terms of SSB indexes are fixed in time. It cannot support the proposed flexible behavior.

In addition, in the current NR system, the UE goes through the following configurations before the UE can be transmitted data based on the reported CSI (including CQI):
1. UE detects SSB;
2. UE determines Type0-PDCCH configuration from PCBH of SSB;
3. UE detects Type0-PDCCH carrying scheduling grant for PDSCH carrying SIB1;
4. UE determines RACH config from SIB1;
5. UE performs random access to the cell:
   a. UE transmits PRACH preamble associated to a selected SSB,
   b. UE receives RAR,
   c. UE transmits Msg3 PUSCH carrying RRC Connection Request message,
   d. UE receives PDSCH carrying RRC Reconfiguration message,
   e. UE transmits HARQ-ACK,
6. UE completes RRC connection setup;
7. UE receives CSI-RS configuration from the gNB;
8. UE performs CSI measurements and transmits CSI report(s) to gNB; and
9. UE receives PDCCH+PDSCH from the gNB based on the reported CSI

One of the challenge or delay causing issue in the current NR system is relatively long time until the UE can be transmitted data based on the reported CSI (including e.g., CQI).

One general procedure of the proposed flexible initial access channel configuration in accordance with example embodiments of the invention is outlined below:
1. Cell access to DS is provided exclusively over lower layer;
2. No more than a few UEs are connected to the DS simultaneously at any given time;
3. Mobility, connection, and control are handled via lower layer;
4. UE may cause triggering of DS cell SSBs/beacons through lower frequency band, otherwise the DS cell SSBs/beacons may remain silent:
   Triggering determined by gNB based on UE pathloss, location, velocity, traffic; and
5. After UE has caused the triggering:
   SSBs and CSI-RS have multiple modes or patterns that are used sequentially in time (see FIG. 1),
   These are indicated to UE prior initial access attempt.

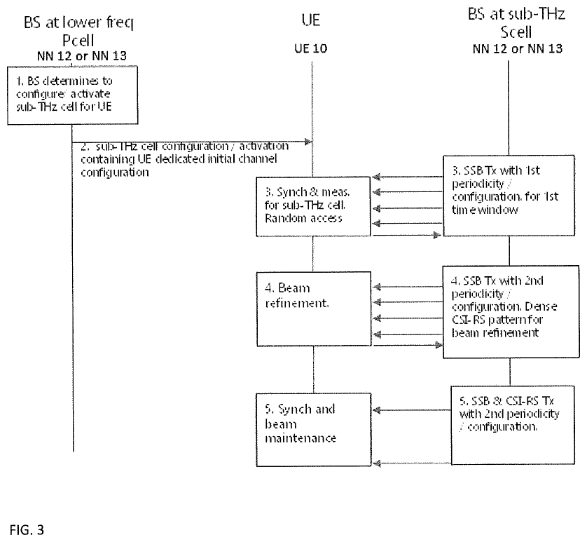

FIG. 2 shows a flexible synchronization signal block design. As shown in FIG. 2 there is an initial SSB pattern encompassing several SSB patterns and an initial CSI-RS pattern for an idle cell and a loaded DS cell with candidate beams, and a modified Sync maintenance pattern for candidate beams. A time pattern is determined based at least periodicity and time offset of the signals, where the time offset may be relative to the frame or slot timing or to some other time reference used in the system. Configuration of time pattern comprises parameter at least for the periodicity.

Particularly, the following modifications into the SSB/CSI-RS configuration is proposed:
SSB/CSI-RS configuration depending
   whether UE is “first” UE on the sub-THz cell or if sub-THz cell is already serving also other UEs
   Which beams (and how many) are determined to be candidate beams for the UE;
When cell is vacant or only one or two UEs in cell, dense synch burst or pattern is used:
   SSBs & CSI-RS transmitted during a predetermined time period, or until UE has accessed the sub-THz cell, and
After initial access, SSBs switch into synch maintenance mode, where SSBs transmitted on even further limited set of beams (based on UE feedback).
   The SSB pattern updated based on UE beam management;
All UE have dedicated configuration of SSBs in maintenance mode (the actual SSB transmissions can be shared of course); and
An SSB may be a signal block containing at least one synchronization signal and a CSI-RS may be a reference signal used for channel state measurement.

Further, to expedite the CSI based data transmission capability, it's proposed that:
UE provides preferred MCS in the Msg3 PUSCH to gNB where the UE may estimate the preferred MCS from the PDSCH carrying the SIB1; and
The gNB could start right after random access procedure transmitting data to UE using MCS (aggressive MCS selection) based on information received on Msg3 before having reported CSI report

By following these lines, the wireless system obtains at least the following advantages:
Shorter initial access time on average and reduced the time when the UE can be transmitted data based on the reported CSI, and
Reduced BS power consumption (i.e., when the BS does not transmit SSBs when there are no UEs in proximity).

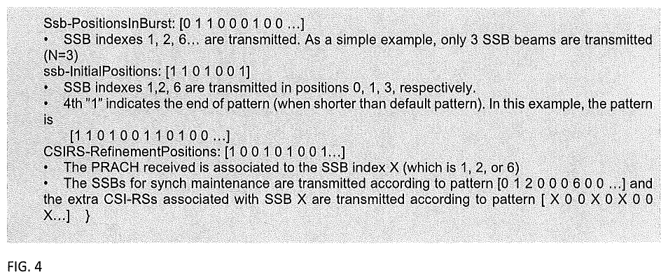

FIG. 3 shows a flow chart of one proposed solution in accordance with example embodiments of the invention. As shown in FIG. 3 the flowchart is between a BS at lower frequency Pcell (BS-Pcell) and BS at sub-THz Scell (BS-Scell) such as the NN 12 and/or NN 13 as in FIG. 5, and a UE such as the UE 10 as in FIG. 5. As shown in step 1 of FIG. 3 the BS-Pcell determines to configure and activate a sub-THz cell for the UE. As shown in step 2 of FIG. 3 the BS-Pcell communicates with the UE a sub-THz configuration and activation configuration containing UE dedicated initial channel configuration. Then as shown in step 3 the UE 10 performs synchronization and measurement for sub-THz cell Random Access, and the BS-Scell performs a SSB transmission with a 1^{st} periodicity and configuration for a 1^{st} time window. In step 4 of FIG. 3 the UE performs beam refinement, and the BS-Scell performs an SSB transmission with a 2^{nd} periodicity and configuration that includes a dense CSI-RS pattern for beam refinement. Then in step 5 of FIG. 3 the UE performs synch and beam maintenance, and the BS-Scell performs an SSB and CSI-RS transmission with a 2^{nd} periodicity and configuration.

It is noted that the BS for lower frequency Pcell and sub-THz Scell may be co-located:
1. Determination may be triggered based on large data volume data to be transmitted to UE and on favorable condition or position of UE w.r.t sub-THz BS. Favorable condition may be identified based on lower layer PL reports/measurements, UE position, velocity, direction etc.;
2. Configuration message contains configuration for initial channels including at least one or more of synchronization signals, broadcast channel providing at least first portion of system information, random access channel, and downlink control channel. They may be e.g., SS, MIB, PBCH, PRACH, PDCCH CORESET 0. It contains multiple configurations for SSB and CSI-RS to be used sequentially;
3. BS transmits SSBs according to first SSB pattern. This first SSB pattern is dense in time meaning that the occasions of SSB transmissions occur at shorter intervals and the number of SSB transmissions in a unit time is higher than in the other SSB patterns. For example, a dense SSB pattern may transmit a full beam sweep in 1/10 or 1/100 the typical interval. Alternatively, dense may also mean that a larger selection of beam directions is swept covering a greater departure angle compared to other SSB patterns. The density may further be adjusted based on existing load on the cell. UE acquires synchronization to the cell and reads PBCH based on first SSB pattern. UE performs random access. UE may also report measurements to PCell, especially in the case of failed random access. The SSB pattern has predefined duration, and it may be ended also by successful random access by the UE. The SSBs may also be limited to directions where UE is going to enter the cell (set of gNB beams or antenna panel). In other words, the beam directions contain only a subset of beam directions where SSB may be transmitted on the cell. In this alternative, only a subset of SSBs covering the subset of beam directions may be transmitted. As SSB may be transmitted on only a subset of beam directions, SSB transmissions on these beam directions occur at shorter intervals than in the other SSB patterns containing SSBs for a larger set of beam directions, even if the intervals between consecutive SSB transmissions on any beam directions would remain the same for all the SSB patterns;
4. After successful random access, BS switches to SSB pattern sufficient for synch maintenance but provides dense CSI-RS pattern for quick beam refinement. The synch maintenance beam pattern will be less dense having fewer SSB occasions in a time interval. Furthermore, the synch maintenance beam pattern may sweep a smaller angle of departure confined to the current position of the UE; and
5. After beam refinement, both SSB and CSI-RS are transmitted with pattern sufficient for synch maintenance and beam management. (Later on, the pattern may be reconfigured so that SSB transmissions are limited to beams serving UEs and likely candidate beams for beam switching);
It is noted that the switching can occur at the end of the first time window or when UE receives a predefined message or the configuration message from network. Further, the message can indicate certain phase of random access, e.g., random access message 2, random access message 4, random access message B the message indicates certain phase of random access, e.g., random access message 2, random access message 4, random access message B. It is noted that the random access message can also be a message 3 or message A.

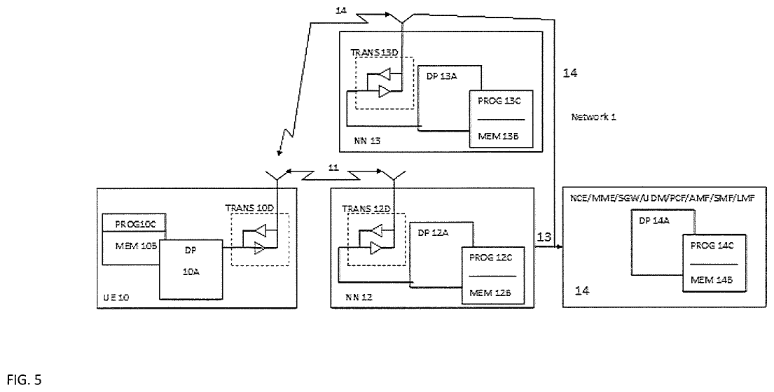

Further details on Step 2:
Step 2 sub-THz cell configuration (see example in FIG. 4):
   ServingCellConfigCommon contains:
      Legacy ssb-PositionsInBurst (64-bit) bit map of transmitted SSB pattern (0—not transmitted/1—transmitted. Let's say that the number of 1s that it contains is N). This provides the sync maintenance pattern;
      ssb-InitialPositions provide initial synch pattern:
         ssb-InitialPositions maps the SSBs (and SSB indexes) of the ssb-PositionsInBurst to the new time locations used during the initial synch burst,
         ssb-InitialPositions can be [1 1 0 1 0 0 1],
         E.g., The end of pattern is indicated by N+1th “1” on the bitmap,
         Related timer indicates the max duration of initial synch burst relative to a time instant derived e.g., based on the timing of RRC message;
      CSIRS-RefinementPositions provide the additional and temporal (limited by a timer) resources for CSI-RS for quick DL beam refinement:
         a bit map that indicates the extra symbols on vacant SSB locations that carry CSI-RS ports associated to the SSB associated to the PRACH occasion used by the UE, and
         Related timer indicates the max duration relative to a time instant derived e.g., based on the timing of e.g., RA message 2, and
         CSIRS-RefinementPositions can be [1 0 0 1 0 1 0 0 1].

FIG. 4 shows an example of the proposed flexible synchronization signal block configuration in accordance with example embodiments of the invention.

As shown in FIG. 4 there is an SSB-PositionsInBurst including SSB indexes and initial positions, and a CSIRS-RefinementPositions including a received PRACH associated with an SSB index, where SSBs for synchronization and maintenance and extra CSI-RSs are transmitted according to a pattern.

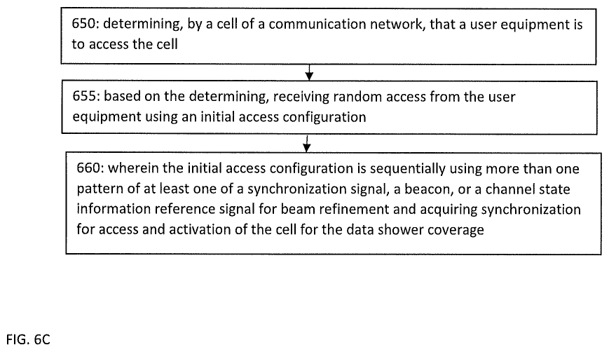

FIG. 6A, FIG. 6B, and FIG. 6C each show a method in accordance with example embodiments of the invention which may be performed by an apparatus.

FIG. 6A illustrates operations which may be performed by a device such as, but not limited to, a device (e.g., the UE 10 as in FIG. 5). As shown in step 605 of FIG. 6A there is determining, by a user equipment of a communication network, that the user equipment is to access a cell for triggering random access to the cell. As shown in step 610 of FIG. 6A wherein the random access is using an initial access configuration communicated by a network node of the communication network. Then as shown in step 615 of FIG. 6A wherein the initial access configuration is sequentially using more than one pattern of at least one of a synchronization signal, a beacon, or a channel state information reference signal for at least one of acquiring synchronization, beam refinement, and beam maintenance for access to the cell.

In accordance with the example embodiments as described in the paragraph above, wherein the network node comprises a primary serving cell and wherein the cell comprises a sub-terahertz secondary cell and wherein the initial access configuration is received from the network node through a frequency band lower than a frequency band of the cell.

In accordance with the example embodiments as described in the paragraphs above, wherein determining to access the sub-terahertz secondary cell is based on an indication from the network node, and wherein the access to the sub-terahertz secondary cell is to perform data shower coverage for the user equipment.

In accordance with the example embodiments as described in the paragraphs above, wherein the more than one pattern is sequentially switched based on at least one of a configured time window, expiration of a timer, or receiving a predefined message from the network node.

In accordance with the example embodiments as described in the paragraphs above, wherein the determining is based on at least one of a lower layer path loss or measurement, position, velocity, or direction reported from the user equipment to the network node.

In accordance with the example embodiments as described in the paragraphs above, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window used for user equipment to acquire synchronization to the cell and read physical broadcast channel.

In accordance with the example embodiments as described in the paragraphs above, wherein initial positions of a subset of synchronization signal blocks of the synchronization signal block transmission provide an initial synchronization pattern of the more than one pattern.

In accordance with the example embodiments as described in the paragraphs above, wherein the positions of the subset of synchronization signal blocks of the synchronization signal block transmission occur in intervals and numbers that are shorter than other synchronization signal block patterns of the communication network to make them occur more densely.

In accordance with the example embodiments as described in the paragraphs above, there is based on the initial access configuration, performing random access with the cell wherein the beam maintenance is using a synchronized maintenance pattern.

In accordance with the example embodiments as described in the paragraphs above, wherein the more than one pattern comprises at least a second configuration comprising a synchronization signal block transmission with a second periodicity and configuration for a second time window used for beam refinement.

In accordance with the example embodiments as described in the paragraphs above, there is following random access, determining the beam refinement based on a switch to a synchronization signal block pattern and a channel state information reference signal pattern provided by the network node.

In accordance with the example embodiments as described in the paragraphs above, wherein the switch occurs at the end of the first time window or when the user equipment receives a predefined message from network.

In accordance with the example embodiments as described in the paragraphs above, wherein determining the beam refinement comprises utilizing a second configuration comprising a synchronization signal block transmission with a second periodicity and configuration.

In accordance with the example embodiments as described in the paragraphs above, wherein the second periodicity is longer than the first periodicity.

In accordance with the example embodiments as described in the paragraphs above, the more than one pattern comprises at least a third configuration and there is following determining the beam refinement, utilizing a third configuration for a synchronization signal block and channel state information reference signal transmission with the second periodicity and configuration for the beam refinement.

In accordance with the example embodiments as described in the paragraphs above, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns.

In accordance with the example embodiments as described in the paragraphs above, wherein the densely provided channel state information reference signal pattern utilizes a timer to indicate a maximum duration of a first configuration related to an initial synchronization burst relative to a time instant derived based on message timing for the random access, wherein a second configuration is used after the timer expires.

In accordance with the example embodiments as described in the paragraphs above, wherein the more than one pattern comprises at least one bit map indicating at least one of ssb-InitialPositions and CSIRS-RefinementPositions.

In accordance with the example embodiments as described in the paragraphs above, wherein the more than one pattern comprises at least a third configuration for beam maintenance, wherein the third configuration comprising: following determining the beam refinement, a third configuration is utilized for a synchronization signal block with at least one of a fourth periodicity, or channel state information reference signal transmission with a fifth periodicity.

In accordance with the example embodiments as described in the paragraphs above, wherein the more than one pattern comprises at least one bit map indicating at least one of ssb-InitialPositions or CSIRS-RefinementPositions.

In accordance with the example embodiments as described in the paragraphs above, wherein the more than one pattern comprises at least a third configuration for beam maintenance, wherein the third configuration comprising: following determining the beam refinement, utilizing the third configuration for a synchronization signal block with at least one of a fourth periodicity, or channel state information reference signal transmission with a fifth periodicity.

In accordance with the example embodiments as described in the paragraphs above, wherein the initial access configuration is received from the network node prior to the random access.

In accordance with the example embodiments as described in the paragraphs above, there is, based on the determining, indicating a preferred modulation and coding scheme for a downlink data transmission in a random access message to the network node.

In accordance with the example embodiments as described in the paragraphs above, wherein the downlink data transmission is received from the network node using an aggressive modulation and coding scheme selection in response to information received in the random access message and before a channel state information report.

A non-transitory computer-readable medium (MEM 10B as in FIG. 5) storing program code (PROG 10C as in FIG. 5), the program code executed by at least one processor (DP 10A as in FIG. 5) to perform the operations as at least described in the paragraphs above.

In accordance with an example embodiment of the invention as described above there is an apparatus comprising: means for determining (TRANS 13D, MEM 10B, PROG 10C, and DP 10A as in FIG. 5), by a user equipment (UE 10 as in FIG. 5) of a communication network (Network 1 as in FIG. 5), that the user equipment is to access a cell for triggering random access to the cell, wherein the random access is using an initial access configuration communicated (TRANS 13D, MEM 10B, PROG 10C, and DP 10A as in FIG. 5) by a network node (NN 12 and/or NN 13 as in FIG. 5) of the communication network, and wherein the initial access configuration is sequentially using (TRANS 13D, MEM 10B, PROG 10C, and DP 10A as in FIG. 5) more than one pattern of at least one of a synchronization signal, a beacon, or a channel state information reference signal for at least one of acquiring synchronization, beam refinement, and beam maintenance for access to the cell.

In the example aspect of the invention according to the paragraph above, wherein at least the means for determining, communicating, and using comprises a non-transitory computer readable medium [MEM 10B as in FIG. 5] encoded with a computer program [PROG 10C as in FIG. 5] executable by at least one processor [DP 10A as in FIG. 5].

FIG. 6B illustrates operations which may be performed by a network device such as, but not limited to, a network node NN 12 or NN 13 as in FIG. 5 or an eNB or gNB. As shown in step 630 of FIG. 6B there is determining, by a network node of a communication network, that a user equipment is to access a cell to trigger random access to the cell for the user equipment. As shown in step 635 of FIG. 6B there is, based on the determining, sending an initial access configuration towards the user equipment for triggering random access to the cell for the user equipment. Then as shown in step 640 of FIG. 6B wherein the initial access configuration is sequentially using more than one pattern of at least one of a synchronization signal, a beacon, or a channel state information reference signal for acquiring synchronization for access, beam refinement, and beam maintenance and activation of the cell for the data shower coverage.

In accordance with the example embodiments as described in the paragraph above, wherein the network node comprises a primary serving cell and wherein the cell comprises a sub-terahertz secondary cell and wherein the initial access configuration is received from the network node through a frequency band lower than a frequency band of the cell.

In accordance with the example embodiments as described in the paragraphs above, wherein the initial access channel configuration is communicated by network node through a frequency band lower than a frequency band of the cell.

In accordance with the example embodiments as described in the paragraphs above, wherein the access to the sub-terahertz secondary cell is to perform data shower coverage for the user equipment.

In accordance with the example embodiments as described in the paragraphs above, wherein the more than one pattern is sequentially switched based on at least one of a configured time window, expiration of a timer, or a predefined message from the network node.

In accordance with the example embodiments as described in the paragraphs above, wherein the determining is based on at least one of a lower layer path loss report or measurement, position, velocity, or direction reported from the user equipment.

In accordance with the example embodiments as described in the paragraphs above, wherein the more than one pattern is sequentially switched based on at least one of a configured time window, expiration of a timer, or a predefined message from the network node.

In accordance with the example embodiments as described in the paragraphs above, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window used for user equipment to acquire synchronization to the cell and read physical broadcast channel.

In accordance with the example embodiments as described in the paragraphs above, wherein initial positions of a subset of synchronization signal blocks of the synchronization signal block transmission provide an initial synchronization pattern of the more than one pattern.

In accordance with the example embodiments as described in the paragraphs above, wherein the positions of the subset of synchronization signal blocks of the synchronization signal block transmission occur in intervals that are shorter and numbers that are greater than other synchronization signal block patterns of the communication network to make them occur more densely.

In accordance with the example embodiments as described in the paragraphs above, wherein the more than one pattern comprises at least a second configuration for beam refinement, wherein the second configuration comprising at least one of a synchronization signal block transmission with a second periodicity, channel state information reference signal transmission with the third periodicity, or configuration for a second time window.

In accordance with the example embodiments as described in the paragraphs above, wherein there is based on the initial access configuration, performing random access with the cell.

In accordance with the example embodiments as described in the paragraphs above, there is following a random access procedure to the sub-terahertz secondary cell by the user equipment, determining a beam refinement based on a switch to a synchronization signal block pattern and a channel state information reference signal pattern provided by the network node.

In accordance with the example embodiments as described in the paragraphs above, wherein the switch occurs at the end of the first time window or when the user equipment receives a predefined message from network.

In accordance with the example embodiments as described in the paragraphs above, wherein determining the beam refinement comprises utilizing a second configuration comprising a synchronization signal block transmission with a second periodicity and configuration.

In accordance with the example embodiments as described in the paragraphs above, wherein the second periodicity is longer than the first periodicity.

In accordance with the example embodiments as described in the paragraphs above, there is following determining the beam refinement, a third configuration is utilized for a synchronization signal block and channel state information reference signal transmission with the second periodicity and configuration for the beam refinement.

In accordance with the example embodiments as described in the paragraphs above, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns.

In accordance with the example embodiments as described in the paragraphs above, wherein the densely provided channel state information reference signal pattern utilizes a timer to indicate a maximum duration of a first configuration related to an initial synchronization burst relative to a time instant derived based on message timing for the random access, wherein a second configuration is used after the timer expires.

In accordance with the example embodiments as described in the paragraphs above, wherein the more than one pattern comprises at least one bit map indicating at least one of ssb-InitialPositions or CSIRS-RefinementPositions: [1 0 0 1 0 1 0 0 1].

In accordance with the example embodiments as described in the paragraphs above, wherein the more than one pattern comprises at least a third configuration for beam maintenance, wherein the third configuration comprising: following determining the beam refinement, utilizing the third configuration for a synchronization signal block with at least one of a fourth periodicity, or channel state information reference signal transmission with a fifth periodicity.

In accordance with the example embodiments as described in the paragraphs above, wherein the initial channel configuration is communicated by the network node prior to the random access.

In accordance with the example embodiments as described in the paragraphs above, wherein the initial access channel configuration is communicated based on a preferred modulation and coding scheme carrying a system information block in a message 3 physical uplink shared channel communicated to the network node from the user equipment.

In accordance with the example embodiments as described in the paragraphs above, wherein the initial access channel configuration is communicated by the network node to the user equipment using an aggressive modulation and coding scheme selection in response to information received in the message 3 and before a channel state information report.

In accordance with the example embodiments as described in the paragraphs above, there is receiving from the user equipment a preferred modulation and coding scheme for a downlink data transmission in a random access message.

In accordance with the example embodiments as described in the paragraphs above, wherein the downlink data transmission is received using an aggressive modulation and coding scheme selection in response to information received in the random access message and before a channel state information report.

A non-transitory computer-readable medium (MEM 12B and/or MEM 13B as in FIG. 5) storing program code (PROG 12C and/or PROG 13C as in FIG. 5), the program code executed by at least one processor (DP 12A and/or DP 13A as in FIG. 5) to perform the operations as at least described in the paragraphs above.

In accordance with an example embodiment of the invention as described above there is an apparatus comprising: means for determining (TRANS 12D and/or TRANS 13D, MEM 12B and/or MEM 13B, PROG 12C and/or PROG 13C, and DP 12A and/or DP 13A as in FIG. 5), by a network node (NN 12 and/or NN 13 as in FIG. 5) of a communication network (Network 1 as in FIG. 5), that a user equipment (UE 10 as in FIG. 5) is to access a cell to trigger random access to the cell for the user equipment; means, based on the determining, for sending (TRANS 12D and/or TRANS 13D, MEM 12B and/or MEM 13B, PROG 12C and/or PROG 13C, and DP 12A and/or DP 13A as in FIG. 5) an initial access configuration towards the user equipment for triggering random access to the cell to perform a data shower coverage for the user equipment, wherein the initial access configuration is sequentially using (TRANS 12D and/or TRANS 13D, MEM 12B and/or MEM 13B, PROG 12C and/or PROG 13C, and DP 12A and/or DP 13A as in FIG. 5) more than one pattern of at least one of a data shower cell synchronization signal, a beacon, or a channel state information reference signal for at least one of acquiring synchronization, beam refinement, and beam maintenance for access to the cell.

In the example aspect of the invention according to the paragraph above, wherein at least the means for determining, sending, and using comprises a non-transitory computer readable medium [MEM 12B and/or MEM 13B as in FIG. 5] encoded with a computer program [PROG 12C and/or PROG 13C as in FIG. 5] executable by at least one processor [DP 12A and/or DP 13C as in FIG. 5].

FIG. 6C illustrates operations which may be performed by a network device such as, but not limited to, a network node NN 12 or NN 13 as in FIG. 5 or a cell device such as a sub-terahertz cell device. As shown in step 650 of FIG. 6C there is determining, by a cell of a communication network, that a user equipment is to access the cell. As shown in step 655 of FIG. 6C, based on the determining, receiving random access from the user equipment using an initial access configuration. Then as shown in step 660 of FIG. 6C wherein the initial access configuration is sequentially using more than one pattern of at least one of a synchronization signal, a beacon, or a channel state information reference signal for acquiring synchronization for access, beam refinement, and beam maintenance and activation of the cell for the data shower coverage.

In accordance with the example embodiments as described in the paragraphs above, wherein the cell comprises a sub-terahertz secondary cell, wherein the initial access channel configuration is from a network node associated with the communication network via the user equipment, and wherein the access to the sub-terahertz secondary cell is to perform data shower coverage for the user equipment.

In accordance with the example embodiments as described in the paragraphs above, wherein the initial access channel configuration is communicated from a network node of the communication network through a frequency band lower than a frequency band of the cell.

In accordance with the example embodiments as described in the paragraphs above, wherein the initial access configuration is sent by a network node of the communication network through a frequency band lower than a frequency band of one of the cell or a primary cell.

In accordance with the example embodiments as described in the paragraphs above, wherein the more than one pattern is sequentially switched based on at least one of a configured time window, expiration of a timer, or a predefined message from the network node.

In accordance with the example embodiments as described in the paragraphs above, wherein the determining is based on at least one of a lower layer path loss report or measurement, position, velocity, or direction reported from the user equipment.

In accordance with the example embodiments as described in the paragraphs above, wherein the more than one pattern comprises at least a first configuration used for the user equipment to acquire synchronization to the cell and read physical broadcast channel, wherein the first configuration comprising at least one of a synchronization signal block transmission with a first periodicity or configuration for a first time window used for user equipment to acquire synchronization to the cell and read physical broadcast channel.

In accordance with the example embodiments as described in the paragraphs above, wherein initial positions of a subset of synchronization signal blocks of the synchronization signal block transmission provide an initial synchronization pattern of the more than one pattern.

In accordance with the example embodiments as described in the paragraphs above, wherein the positions of the subset of synchronization signal blocks of the synchronization signal block transmission occur in intervals that are shorter and numbers that are greater than other synchronization signal block patterns of the communication network to make them occur more densely.

In accordance with the example embodiments as described in the paragraphs above, wherein the more than one pattern comprises at least a second configuration for beam refinement, wherein the second configuration comprising at least one of a synchronization signal block transmission with a second periodicity, channel state information reference signal transmission with the third periodicity, or configuration for a second time window.

In accordance with the example embodiments as described in the paragraphs above, wherein the initial access channel configuration includes a random access configuration, a beam refinement configuration and a beam maintenance configuration, and wherein the beam maintenance configuration is using a synchronized maintenance pattern.

In accordance with the example embodiments as described in the paragraphs above, there is following a random access procedure to the cell by the user equipment, determining a beam refinement based on a switch to a synchronization signal block pattern and a channel state information reference signal pattern provided by the network node.

In accordance with the example embodiments as described in the paragraphs above, wherein the switch occurs at the end of the first time window or when the user equipment receives a predefined message from network.

In accordance with the example embodiments as described in the paragraphs above, wherein determining the beam refinement comprises utilizing a second configuration comprising a synchronization signal block transmission with a second periodicity and configuration.

In accordance with the example embodiments as described in the paragraphs above, wherein the second periodicity occur in intervals and numbers that are greater than other synchronization signal block transmissions of the communication network.

In accordance with the example embodiments as described in the paragraphs above, wherein the second periodicity is longer than the first periodicity.

In accordance with the example embodiments as described in the paragraphs above, there is following determining the beam refinement, a third configuration is utilized for a synchronization signal block and channel state information reference signal transmission with the second periodicity and configuration for the beam refinement.

In accordance with the example embodiments as described in the paragraphs above, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns.

In accordance with the example embodiments as described in the paragraphs above, wherein the densely provided channel state information reference signal pattern utilizes a timer to indicate a maximum duration of a first configuration related to an initial synchronization burst relative to a time instant derived based on message timing for the random access, wherein a second configuration is used after the timer expires.

In accordance with the example embodiments as described in the paragraphs above, wherein the more than one pattern comprises at least one bit map indicating at least one of ssb-InitialPositions or CSIRS-RefinementPositions.

In accordance with the example embodiments as described in the paragraphs above, wherein the more than one pattern comprises at least a third configuration for beam maintenance, wherein the third configuration comprising:
following determining the beam refinement, utilizing the third configuration for a synchronization signal block with at least one of a fourth periodicity, or channel state information reference signal transmission with a fifth periodicity.

In accordance with the example embodiments as described in the paragraphs above, wherein the initial access channel configuration is communicated by the network node in response to the random access.

In accordance with the example embodiments as described in the paragraphs above, wherein the initial access channel configuration is communicated based on a preferred modulation and coding scheme carrying a system information block in a message 3 physical uplink shared channel communicated to the network node from the user equipment.

In accordance with the example embodiments as described in the paragraphs above, wherein the initial access channel configuration is using an aggressive modulation and coding scheme selection in response to information received in the message 3 and before a channel state information report.

A non-transitory computer-readable medium (MEM 12B and/or MEM 13B as in FIG. 5) storing program code (PROG 12C and/or PROG 13C as in FIG. 5), the program code executed by at least one processor (DP 12A and/or DP 13A as in FIG. 5) to perform the operations as at least described in the paragraphs above.

In accordance with an example embodiment of the invention as described above there is an apparatus comprising: means for determining (TRANS 12D and/or TRANS 13D, MEM 12B and/or MEM 13B, PROG 12C and/or PROG 13C, and DP 12A and/or DP 13A as in FIG. 5), by a cell of a communication network (Network 1 as in FIG. 5), that a user equipment (UE 10 as in FIG. 5) is to access the cell; based on the determining, receiving (TRANS 12D and/or TRANS 13D, MEM 12B and/or MEM 13B, PROG 12C and/or PROG 13C, and DP 12A and/or DP 13A as in FIG. 5) an initial access channel configuration via the user equipment triggering (TRANS 12D and/or TRANS 13D, MEM 12B and/or MEM 13B, PROG 12C and/or PROG 13C, and DP 12A and/or DP 13A as in FIG. 5) random access to the cell to perform a data shower coverage for the user equipment, wherein the initial access channel configuration is sequentially using (TRANS 12D and/or TRANS 13D, MEM 12B and/or MEM 13B, PROG 12C and/or PROG 13C, and DP 12A and/or DP 13A as in FIG. 5) more than one pattern of at least one of a data shower cell synchronization signal, a beacon, or a channel state information reference signal for beam refinement and acquiring synchronization for access and activation of the cell for the data shower coverage.

In the example aspect of the invention according to the paragraph above, wherein at least the means for determining, receiving, triggering, and using comprises a non-transitory computer readable medium [MEM 12B and/or MEM 13B as in FIG. 5] encoded with a computer program [PROG 12C and/or PROG 13C as in FIG. 5] executable by at least one processor [DP 12A and/or DP 13C as in FIG. 5].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii)) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A method, comprising:
determining, by a user equipment of a communication network, that the user equipment is to access a cell for triggering random access to the cell;
wherein the random access is using an initial access configuration communicated by a network node of the communication network, and
wherein the initial access configuration is sequentially using more than one pattern of at least one of a synchronization signal, a beacon, or a channel state information reference signal for at least one of acquiring synchronization, beam refinement, and beam maintenance for access to the cell.

2. The method of claim 1, wherein the network node comprises a primary serving cell and wherein the cell comprises a sub-terahertz secondary cell and wherein the initial access configuration is received from the network node through a frequency band lower than a frequency band of the cell.

3. The method of claim 2, wherein determining to access the sub-terahertz secondary cell is based on an indication from the network node, and wherein the access to the sub-terahertz secondary cell is to perform data shower coverage for the user equipment.

4. The method of claim 1, wherein the more than one pattern is sequentially switched based on at least one of a configured time window, expiration of a timer, or receiving a predefined message from the network node.

5. The method of claim 1, wherein the determining is based on at least one of a lower layer path loss or measurement, position, velocity, or direction reported from the user equipment to the network node.

6. The method of claim 1, wherein the more than one pattern comprises at least a first configuration used for the user equipment to acquire synchronization to the cell and read physical broadcast channel, wherein the first configuration comprising at least one of a synchronization signal block transmission with a first periodicity and/or configuration for a first time window.

7. The method of claim 1, wherein initial positions of a subset of synchronization signal blocks of the synchronization signal block transmission provide an initial synchronization pattern of the more than one pattern.

8. The method of claim 7, wherein the initial positions of the subset of synchronization signal blocks of the synchronization signal block transmission occur in intervals that are shorter and numbers that are greater than other synchronization signal block patterns of the communication network to make them occur more densely.

9. (canceled)

10. The method of claim 1, wherein the more than one pattern comprises at least a second configuration for beam refinement, wherein the second configuration comprising at least one of a synchronization signal block transmission with a second periodicity, channel state information reference signal transmission with the third periodicity, or configuration for a second time window.

11. The method of claim 10, comprising:
following the random access, determining the beam refinement based on a switch to a synchronization signal block pattern and/or a channel state information reference signal pattern provided by the network node.

12. The method of claim 11, wherein the switch occurs at the end of the first time window or when the user equipment receives a predefined message from network.

13. The method of claim 10, wherein the second periodicity is longer than the first periodicity.

14. The method of claim 10, wherein the channel state information reference signal pattern is made sufficiently dense for determining the beam refinement, wherein the dense channel state information reference signal pattern comprises at least one of a full 1/10 or 1/100 interval beam sweep, or a selection of beam covering a greater departure angle compared to other synchronization signal block patterns.

15. The method of claim 14, wherein the densely provided channel state information reference signal pattern utilizes a timer to indicate a maximum duration of the first configuration related to an initial synchronization burst relative to a time instant derived based on message timing for the random access, wherein the second configuration is used after the timer expires.

16. The method of claim 15, wherein the more than one pattern comprises at least one bit map indicating at least one of ssb-InitialPositions or CSIRS-RefinementPositions.

17. The method of claim 1, wherein the more than one pattern comprises at least a third configuration for beam maintenance, wherein the third configuration comprising:
following determining the beam refinement, utilizing the third configuration for a synchronization signal block with at least one of a fourth periodicity, or channel state information reference signal transmission with a fifth periodicity.

18. The method of claim 1, wherein at least one of the following occurs: the initial access configuration is received from the network node prior to the random access or, based on the initial access configuration, random access is performed with the cell.

19. The method of claim 1, further comprising:
based on the determining, indicating a preferred modulation and coding scheme for a downlink data transmission in a random access message to the network node.

20. The method of claim 19, wherein the downlink data transmission is received from the network node using an aggressive modulation and coding scheme selection in response to information received in the random access message and before a channel state information report.

21. An apparatus comprising:
at least one processor; and
at least one non-transitory memory including computer program code, where the at least one non-transitory memory and the computer program code are configured, with the at least one processor, to cause the apparatus to at least:
determine, by the apparatus, that the apparatus is to access a cell for triggering random access to the cell;
wherein the random access is using an initial access configuration communicated by a network node of the communication network, and
wherein the initial access configuration is sequentially using more than one pattern of at least one of a synchronization signal, a beacon, or a channel state information reference signal for at least one of acquiring synchronization, beam refinement, and beam maintenance for access to the cell.

22-62. (canceled)
